(19) United States
(12) Patent Application Publication
(10) Pub. No.: US 2019/0032835 A1
(43) Pub. Date: Jan. 31, 2019

(54) PIPE REHABILITATION METHOD

(71) Applicant: SHONAN GOSEI-JUSHI SEISAKUSHO K.K., Kanagawa (JP)

(72) Inventors: Tae Soo CHANG, Buyeo-gun (KR); Kenji FUJII, Kanagawa (JP)

(21) Appl. No.: 16/045,364

(22) Filed: Jul. 25, 2018

(30) Foreign Application Priority Data
Jul. 31, 2017 (KR) 10-2017-0096971

(51) Int. Cl. F16L 55/163; F16L 55/165; F16L 55/1645

(52) U.S. Cl. CPC F16L 55/163; F16L 55/1656; F16L 55/18; F16L 55/16455; F16L 55/1652

(57) ABSTRACT

Segments are linked in the circumferential direction and in the pipe-length direction to assemble a rehabilitation pipe inside an existing pipe in order to rehabilitate the existing pipe. A stackable spacer that is held by a spacer holder is inserted between the existing pipe and the rehabilitation pipe to adjust the position of the rehabilitation pipe relative to the existing pipe. The spacer holder is provided with a movable member that is movable in the circumferential and vertical directions between the inner wall surfaces thereof. The movable member is positioned in the circumferential and vertical directions depending upon the circumferential width of the spacer and the number of spacers stacked. The spacer is held between the positioned movable member and the inner wall surface of the spacer holder.

### TECHNICAL FIELD

The present invention relates to a pipe rehabilitation method for rehabilitating an existing pipe using segments each comprising an inner surface plate constituting an inner circumferential surface, and side plates and end plates provided upright on peripheral edges of the inner surface plate, wherein the inner surface plate, the side plates, and the end plates are formed integrally from a plastic material and the segments are linked in the circumferential direction and in the pipe-length direction to construct a rehabilitation pipe inside an existing pipe.

### BACKGROUND ART

In cases in which a large-diameter existing pipe such as a sewage pipe buried underground has deteriorated through aging, a repairing method has been practiced in which a lining is provided to the inner circumferential surface thereof to repair a pipeline without excavating it from the ground. In this method, the segments as mentioned above are linked in the circumferential direction to assemble pipe units, which are then linked in the pipe-length direction using a linking member to construct a rehabilitation pipe inside the existing pipe. After assembling the rehabilitation pipe inside the existing pipe, a filler such as grout is injected into a space between the existing pipe and the rehabilitation pipe and hardened to construct a composite pipe.

When the filler is injected between the existing pipe and the rehabilitation pipe, the rehabilitation pipe floats on the filler because the rehabilitation pipe is made of a plastic material having a specific gravity lower than the filler. To prevent the rehabilitation pipe from floating, a spacer comprising two wedge-shaped members as disclosed in Patent Document 1 or a spacer having an elongated shape as disclosed in Patent Document 2 is inserted in a gap between the rehabilitation pipe and the existing pipe every time the rehabilitation pipe is assembled a predetermined length (for example, one meter). This ensures that the rehabilitation pipe is pressed downward and the position of the rehabilitation pipe is adjusted for filler injection.

The spacer is pushed with a tension between the rehabilitation pipe and the existing pipe, so that, if the spacer is inappropriately inserted, it falls down or deviates from an appropriate position, causing the rehabilitation pipe to be maladjusted. Therefore, a spacer holder for holding a spacer as disclosed in Patent Document 3 is attached to the segment to prevent the spacer from falling down or from deviating from an appropriate position.

### PRIOR ART DOCUMENTS

### Patent Documents

Patent Document 1: JP 2005-265070 A

Patent Document 2: JP 2016-148406 A

Patent Document 3: JP 2017-25976 A

### SUMMARY OF INVENTION

### Problems to be Solved

The spacer holder as disclosed in Patent Document 3 can prevent the spacer with the two wedge-shaped members overlapped from falling down or deviating from an appropriate position, but cannot prevent the elongated spacer from falling down or being misaligned.

The present invention is made in view of such problems and an object thereof is to provide a pipe rehabilitation method being capable of preventing an elongated spacer from falling down or deviating from an appropriate position and capable of adjusting the position of a rehabilitation pipe relative to an existing pipe.

### Means for Solving the Problems

The present invention concerns a pipe rehabilitation method in which segments are linked in the circumferential direction and in the pipe-length direction to assemble a rehabilitation pipe inside an existing pipe and rehabilitate the existing pipe. The invention comprises linking the segments in the circumferential direction to assemble a pipe unit; attaching to the segment using a spacer holder a stackable elongated spacer that is inserted between the existing pipe and the rehabilitation pipe to adjust the position of the rehabilitation pipe inside the existing pipe; linking the pipe units in the pipe-length direction while adjusting the position of the rehabilitation pipe relative to the existing pipe using the spacer; and injecting a filler between the rehabilitation pipe and the existing pipe after installing the rehabilitation pipe inside the existing pipe. The spacer holder is provided with a movable member that is movable in the circumferential direction and in the vertical direction between the surfaces of inner walls that are formed on both circumferential ends thereof, and the movable member is positioned in the circumferential and vertical directions depending upon the circumferential width of the spacer and the number of spacers stacked, the spacer being held between the positioned movable member and the inner wall surface of the spacer holder.

### Effect of the Invention

According to the present invention, an elongated stackable adjusting spacer is held between the inner wall surface of the spacer holder and the movable member that is positioned depending upon the circumferential width of the spacer and the number of spacers stacked. This ensures that the spacer is firmly attached to the segment, thus preventing the spacer from falling down or deviating from an appropriate position during a rehabilitation work to allow the rehabilitation pipe to be appropriately positioned relative to the existing pipe and the filler to be reliably injected between the existing pipe and the rehabilitation pipe.

### BRIEF DESCRIPTION OF DRAWINGS

FIG. 1 is a perspective view showing the structure of a segment used in assembling the rehabilitation pipe;

FIG. 2 is a perspective view showing a state in which the segments are linked in the circumferential direction to assemble a pipe unit;

FIG. 3 is an illustrative view showing a state in which the segments of the pipe units are linked in the pipe-length direction using linking members;

FIG. 4 is an illustrative view showing a state in which a rehabilitation pipe is installed inside an existing pipe;

FIG. 5a is a top view of a spacer;

FIG. 5b is a side view thereof;

FIG. 5c is a bottom view thereof;

FIG. 5d is a cross-sectional view along line A-A′ in FIG. 5a;

FIG. 6 is a cross-sectional view showing two spacers stacked;

FIG. 7 is an illustrative view showing a state in which spacers are used to adjust a gap between the outer circumference of the rehabilitation pipe and the inner wall surface of the existing pipe;

FIG. 8 is a perspective view showing a spacer holder;

FIG. 9a is a front view of the spacer holder;

FIG. 9b is a top view thereof;

FIG. 9c is a side view thereof;

FIG. 10a is a side view showing one side of a movable member that is attached to the spacer holder;

FIG. 10b is a side view showing the other side thereof;

FIG. 11 is a perspective view showing a state in which the movable member is attached to the spacer holder;

FIG. 12 is an illustrative view showing a state in which the movable member engages with the spacer holder;

FIG. 13 is a perspective view showing a spacer holder that is attached to the segment;

FIG. 14 is a perspective view showing a state in which a spacer holder that holds the spacer is attached to the segment;

FIG. 15 is an illustrative view showing a state in which the position of the rehabilitation pipe is adjusted using the spacer; and

FIG. 16 is an illustrative view showing a state in which two spacers are stacked and held by the spacer holder.

### MODE OF CARRYING OUT THE INVENTION

The present invention will now be described with references to embodiments illustrated in the accompanying drawings. The present invention is suitable for rehabilitating or repairing sewage pipes, water supply pipes, tunnels, agricultural irrigation channels, and other existing large-diameter pipes. In the present embodiment, the rehabilitation pipes are described as having a circular cross-section profile orthogonal to the pipe-length direction. However, it shall be apparent that the present invention can be applied to a rehabilitation pipe having a square or another non-circular cross-section. Also, in addition to structures in which the cross-section profile is closed as a pipe, a structure having a horseshoe-shaped, semi-circular, U-shaped, or another cross-section profile in which one side is open can also be considered to be a pipe, and the present invention can also be applied thereto.

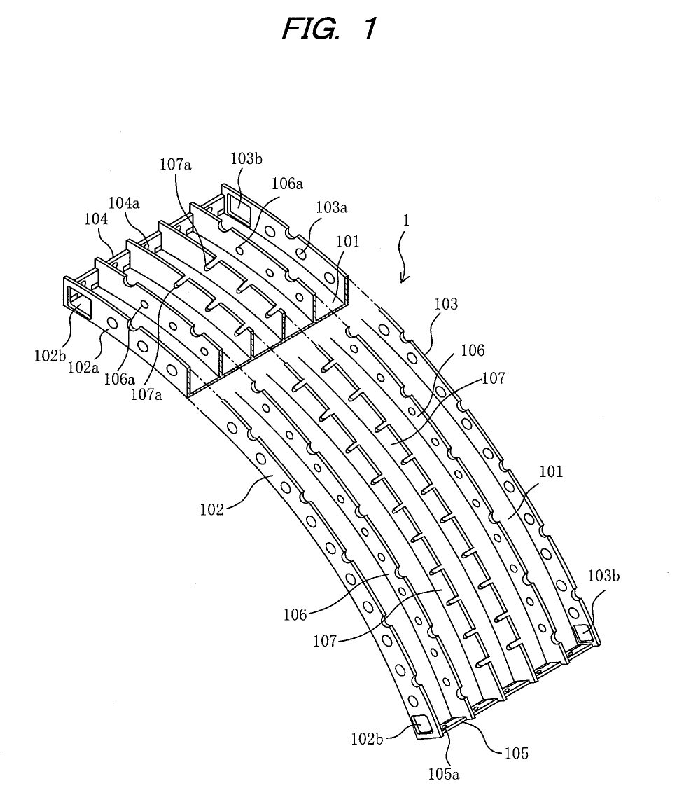

FIG. 1 shows the structure of a segment 1 for pipe rehabilitation (hereafter simply referred to as “segment”). The segment 1 is an integrally formed block-shaped member made from a plastic material, comprising an inner surface plate 101 constituting an inner circumferential surface of the rehabilitation pipe, side plates 102, 103 of the same shape provided vertically upright on both sides extending in the circumferential direction of the inner surface plate 101, and end plates 104, 105 of the same shape provided vertically upright on both ends extending in the pipe-length direction of the inner surface plate 101.

In the present embodiment, the segment 1 has a shape that is curved as an arc representing a predetermined angle that equally divides the circumference, e.g., a 60° arc that divides the circumference into sixths. However, the segment is not limited to that having an arc or a fan shape. The segment may be shaped as, e.g., a cuboid or a shape that is bent so as to have a curved right angle depending on the cross-section profile or the size of the existing pipe or the location of the existing pipe to be repaired.

A plurality (four in the present embodiment) of inner plates 106, 107 having a shape similar to that of the side plates are provided upright at equal intervals and parallel to the side plates 102, 103 on the upper surface of the inner surface plate 101 and on the inside relative to the side plates 102, 103 in order to reinforce the mechanical strength of the segment 1. The side plates 102, 103 and the inner plates 106, 107 are all equal in thickness in the pipe-length direction.

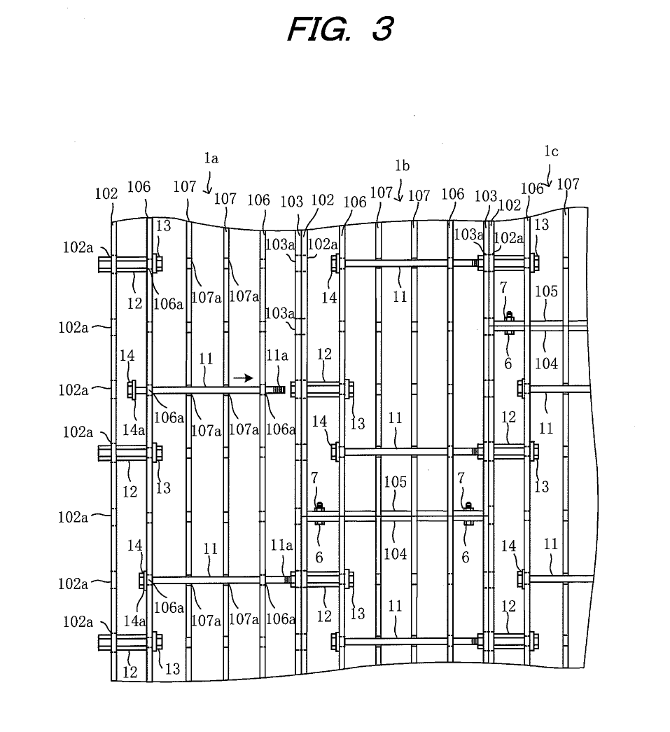

A plurality of circular insertion holes 102a and 103a for admitting insertion of a liking member 11 constituted as a bolt and a nut 12 (FIG. 3) for linking the segment 1 in the pipe-length direction are provided at equal intervals along the circumference on the side plates 102 and 103. The inner plate 106 is also provided at equal intervals with a plurality of circular insertion holes 106a for admitting insertion of the linking member 11. The inner plate 107 is provided at equal intervals with a plurality of notches 107a to admit insertion of the linking member in the pipe-length direction. The insertion holes 102a, 103a and 106a, and the notches 107a are located at coinciding positions along the circumferential direction.

The end plates 104 and 105 are disposed between the side plate 102 and the side plate 103 and are provided with a plurality of circular insertion holes 104a, 105a for admitting insertion of a bolt or another linking member for linking the segments in the circumferential direction.

The inner surface plate 101, the side plates 102, 103, the end plates 104, 105, and the inner plates 106, 107 are all made from an identical transparent, semi-transparent or opaque plastic material, and are integrally formed using a known molding technique.

The end plate 105 of one segment is aligned with the end plate 104 of another segment, and a bolt 6 and a nut 7 (FIG. 3) are inserted into the openings 102b, 103b on the side plates 102, 103, and the bolt 6 is screwed into the nut 7 to link the segments in the circumferential direction.

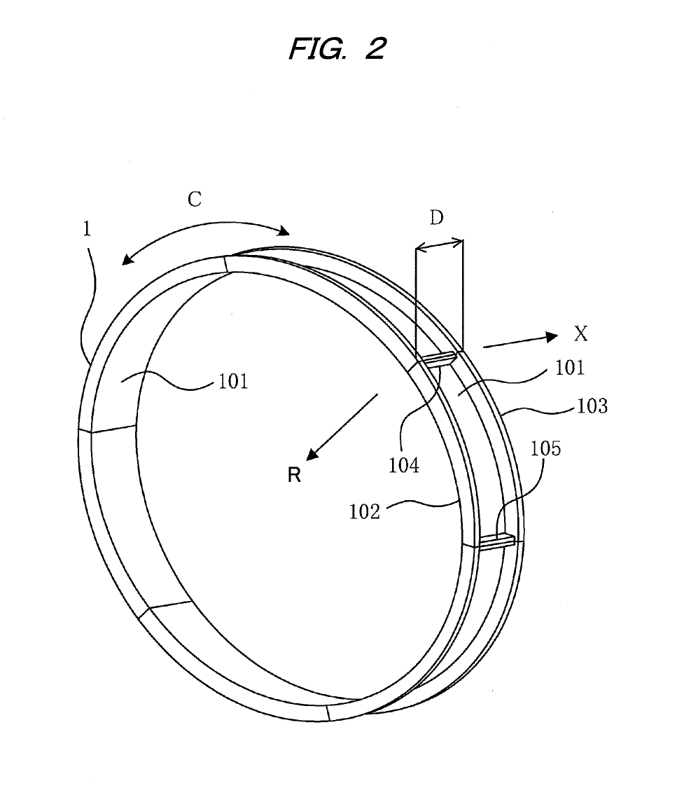

As shown in FIG. 2, the segments 1 are sequentially linked around the full circumference to assemble a ring-shaped pipe unit 10. The pipe unit 10 has a shape that can be obtained when a circular pipe is sliced at a predetermined width D perpendicularly to the pipe-length direction X. The outside diameter of the pipe unit 10 is slightly smaller than the inside diameter of the existing pipe to be rehabilitated. The segment 1 corresponds to a member obtained by dividing the pipe unit 10 in the circumferential direction C into a plurality of (preferably equal) portions along a cutting surface parallel to the radial direction R.

In FIG. 2, the inner surface plate 101, the side plates 102, 103, and the end plates 104, 105, which are the principal structural members of the segment 1, are shown. In order to prevent the drawing from becoming complicated, the inner plates 106, 107 and other reinforcement structures are not shown.

The segments of the pipe unit 10 are sequentially linked to those of the other pipe units in the pipe-length direction using a linking member 11 and a nut 12 as shown in FIG. 3. This allows the pipe units 10 to be sequentially linked in the pipe-length direction.

To link the segments in the pipe-length direction, the nuts 12 are fixed to one of the side plates of the segment using a bolt 13. The length of the nut 12 in the pipe-length direction is slightly greater than the spacing between the side plate 102 and the inner plate 106, and the nut 12 protrudes outwards from the side plate 102 by an amount equivalent to or greater than the thickness of the side plate 103 of another segment. The linking member 11 is configured as a metallic bolt, having at one end a section 11a screwed into the nut 12 and at the other end a head 14 having a flange section 14a.

To link the segment 1a to the segment 1b, the nut 12 that protrudes from the side plate 102 of the segment 1b is, as shown in FIG. 3, inserted through the insertion hole 103a in the side plate 103 of the segment 1a in order to place the side plates 103, 102 of the segments 1a, 1b against each other. The linking member 11 is then passed through the insertion hole 102a in the side plate 102, the insertion holes 106a of the inner plate 106, and the notches 107a of the inner plate 107 of the segment 1a, and a threaded section 11a thereof is screwed into the nut 12 that is fixed to the segment 1b. This causes the linking member 11 to be linked to the nut 12. The linking member 11 is further screwed into the nut 12 until a flange section 14a of the head 14 presses against the leftmost inner plate 106 of the segment 1a, thus bolting and fixing the two segments 1a, 1b.

The segments of the pipe unit are thus linked to the segments of the other pipe unit in the pipe-length direction, allowing the pipe units to be linked in the pipe-length direction to a desired length.

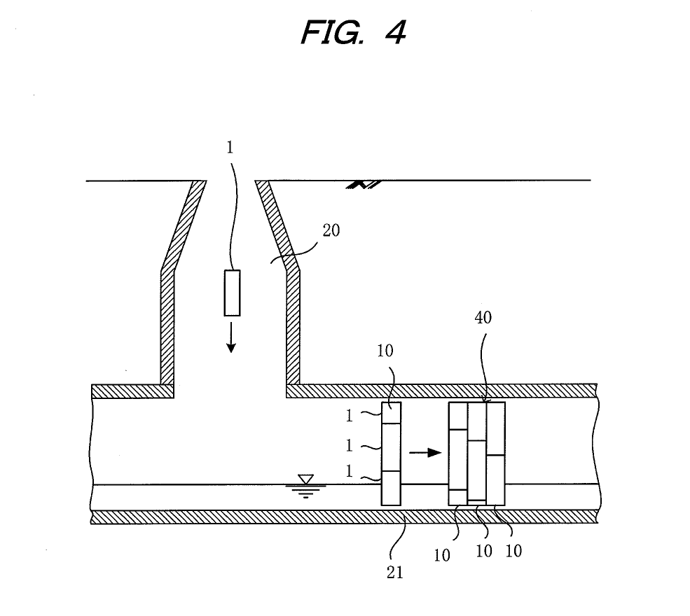

To rehabilitate the existing pipe using the segments, the segments 1 are first carried into a manhole 20, as shown in FIG. 4, and are sequentially linked in the circumferential direction to assemble the pipe unit 10. The pipe units 10 are then sequentially linked in an existing pipe 21 in the pipe-length direction using the linking member 11 and the nut 12, as shown in FIG. 3, thus installing a rehabilitation pipe 40 inside the existing pipe 21. A filler 30 such as grout material is then injected into a space between the rehabilitation pipe 40 and the existing pipe 21. Once the filler 30 hardens, a composite pipe is provided which comprises the rehabilitation pipe 40, the existing pipe 21 and the filler 30.

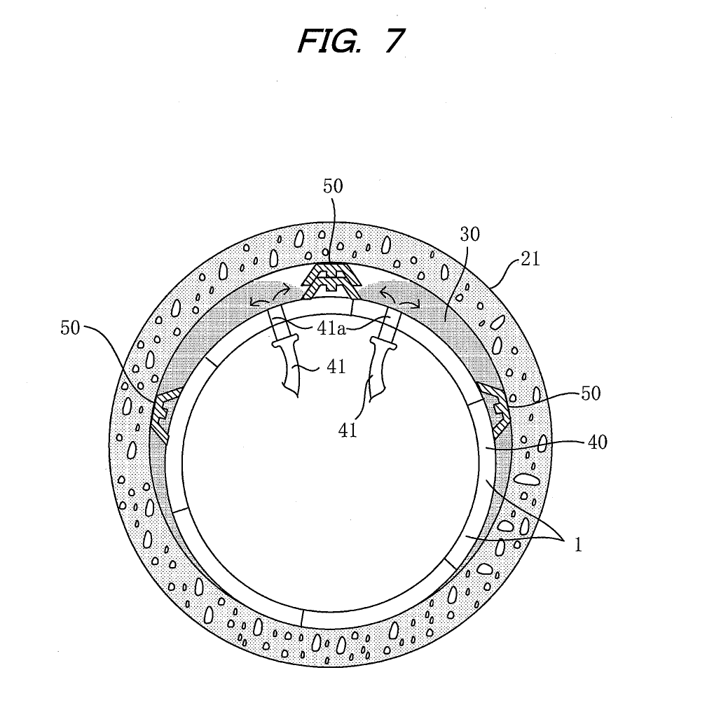

In such a rehabilitation work, an injection hole 41a is, as shown in FIG. 7, drilled in the segment 1 after the rehabilitation pipe 40 is installed inside the existing pipe 21, and an injection hose 41 is used to inject the filler 30 through the injection hole 41a into the space between the rehabilitation pipe 40 and the existing pipe 21. In this step, a spacer 50 is inserted between the rehabilitation pipe 40 and the existing pipe 21 to adjust the position of the rehabilitation pipe 40.

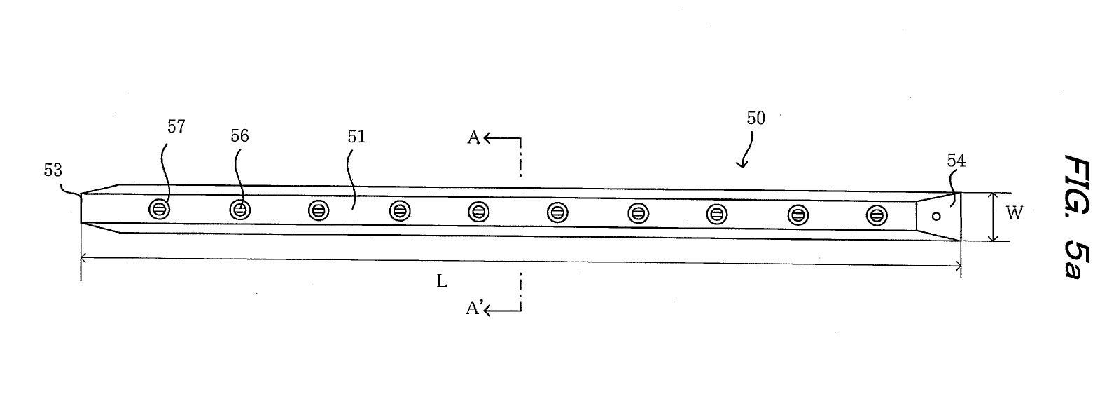

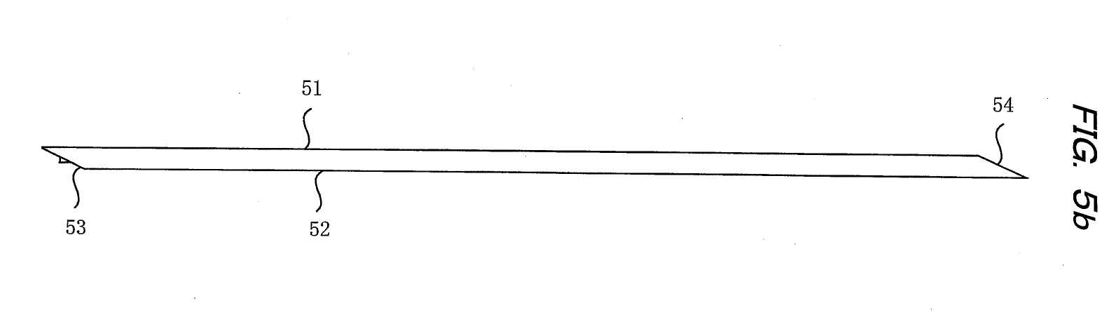

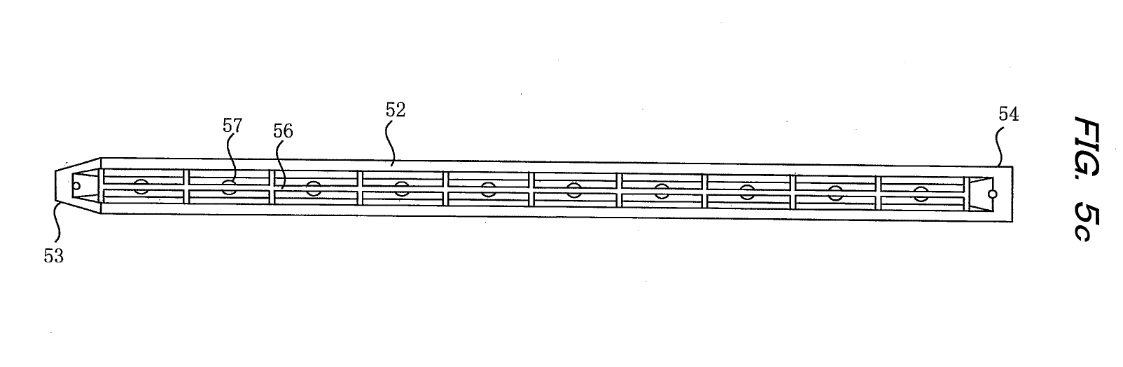

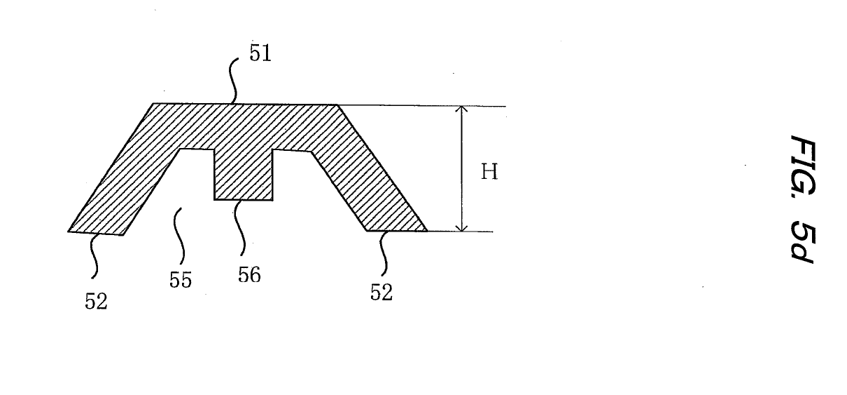

The spacer 50 is, as shown in FIG. 5a through 5d, an elongated member in a trapezoidal shape in cross-section, having an upper surface portion 51 shorter in width than a lower surface portion 52, and is similar in shape as disclosed in Patent Document 2. The spacer 50 is inclined at longitudinal ends 53, 54 in the same direction for linkage to each other in the longitudinal direction. The spacer 50 is provided at a bottom portion with a space 55 which corresponds to the shape of the upper surface portion 51 and in which a reinforcement rib 56 is formed to enhance the rigidity thereof. The spacer 50 is further provided at the upper surface portion 51 with a plurality of circular holes 57 through which a filler can pass.

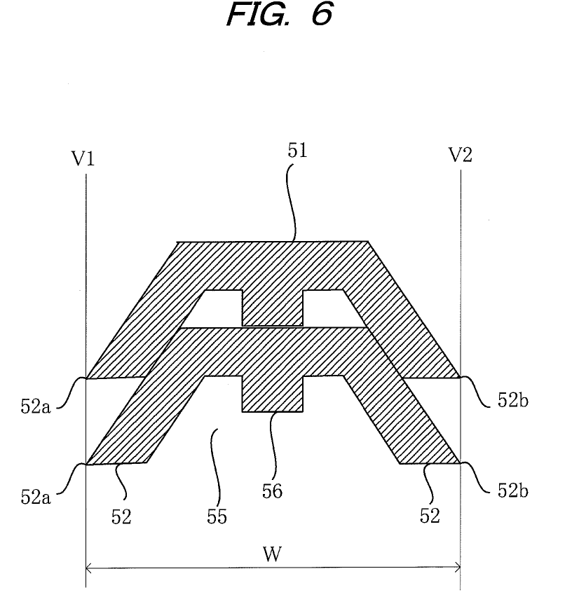

The spacer 50 has a length of L, a width of W and a height of H, the parameters L, W, and H being variable depending on the type and shape of the segment. As shown in FIG. 6, two spacers can be stacked by fitting one spacer into the space 55 of the other. Similarly, three or more spacers can be stacked up for increase in height. When a plurality of spacers are stacked, the left edges 52a at the bottom portions 52 lie on the same vertical line V1 and the right edges 52b also lie on the same vertical line V2 that is parallel to the vertical line V1.

As shown in FIG. 7, one spacer 50 or more depending on a gap between the existing pipe 21 and the rehabilitation pipe 40 are inserted into the gap to push the rehabilitation pipe 40 downward for positional adjustment of the rehabilitation pipe 40 relative the existing pipe 21.

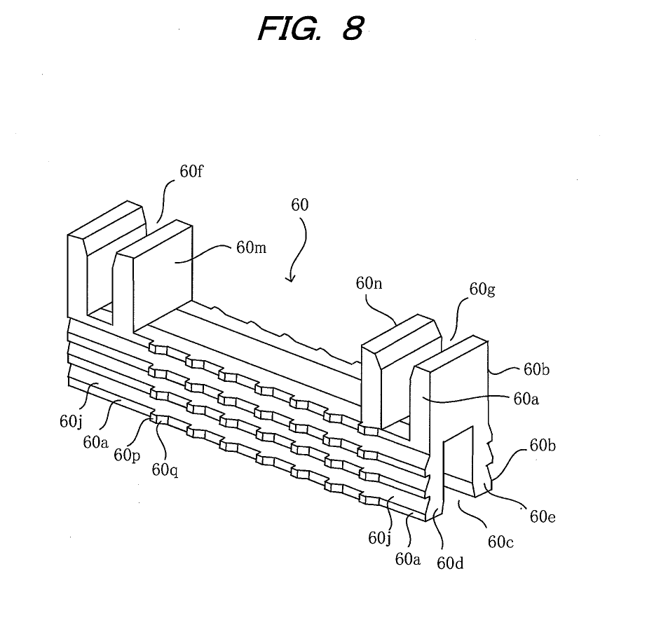

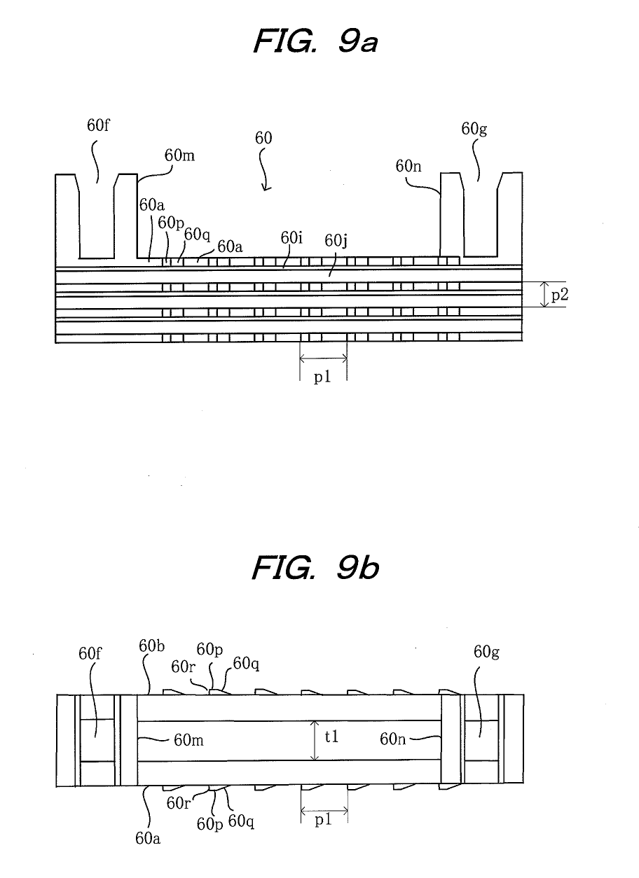

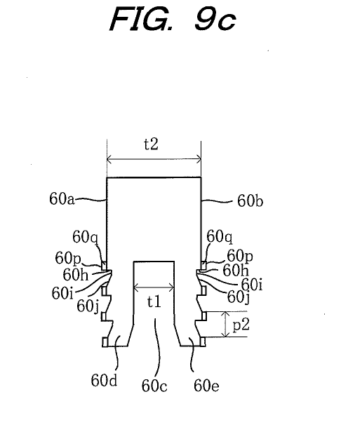

Misalignment of the spacer 50 would cause the spacer 50 to fall down or deviate from an appropriate position, causing the rehabilitation pipe 40 to be maladjusted. To prevent this, a spacer holder 60 as shown in FIG. 8 is used in the present embodiment to hold the spacer 50 on the segment. FIG. 9a shows the spacer holder 60 in front view; FIG. 9b in top view; and FIG. 9c in side view.

The spacer holder 60 is a rectangular parallelepiped block-shaped member made of plastic, having a front surface 60a and a rear surface 60b in the pipe-length direction (longitudinal direction). As will be described below, the protrusions and recesses are complicatedly formed at the lower portions of the front surface 60a and the rear surface 60b, which are thus uneven. However, the front surface 60a and the rear surface 60b are originally flat and extend in the vertical direction before forming the protrusions and recesses thereon. The spacer holder 60 has at the center and lower portions a groove 60c that extends with a width t1 all over the length in the circumferential direction (in the left and right directions) to form legs 60d, 60e in the longitudinal direction.

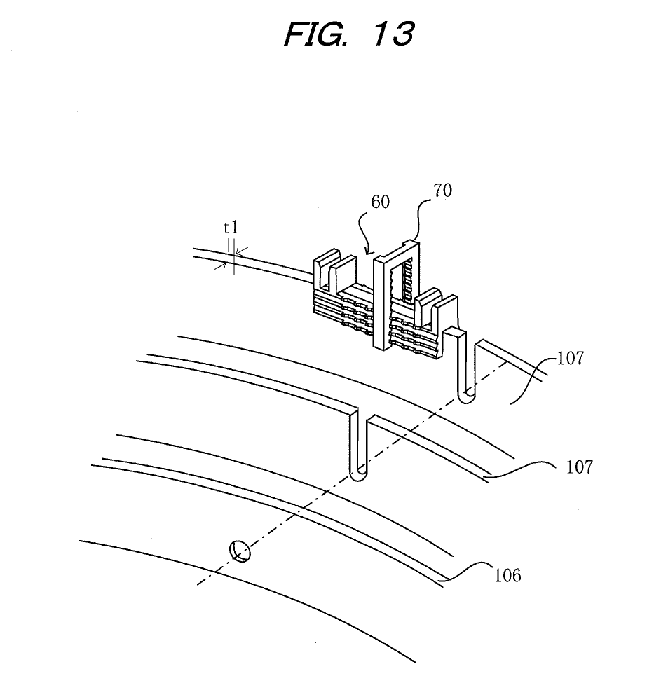

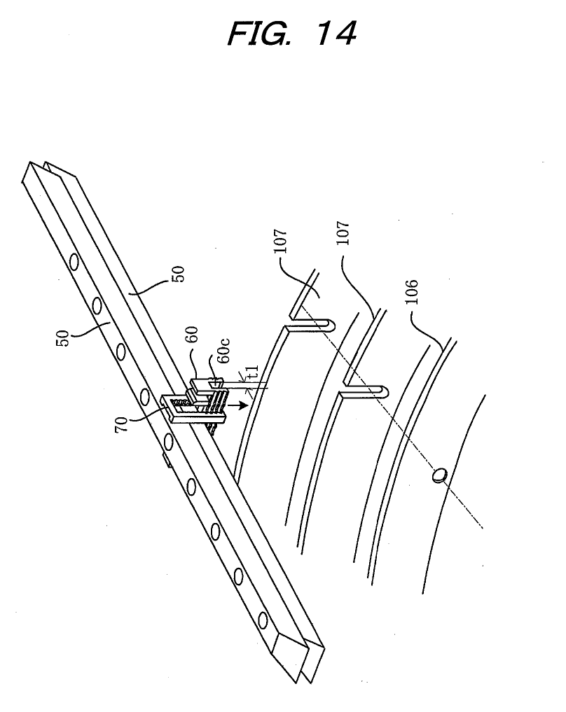

The width t1 of the groove 60c is set so as to be equal to the plate thickness of the side plates 102, 103 and the inner plates 106, 107 of the segment 1. Such a setting enables one of the side plates and inner plates, for example, the inner plate 107 to be pressed into the groove 60c of the spacer holder 60 for attachment of the spacer holder 60 to the inner plate 107, as shown in FIGS. 13 and 14.

The spacer holder 60 is provided at both ends in the circumferential direction with inner walls with grooves 60f, 60g having inner wall surfaces 60m, 60n that extend parallel to each other in the pipe-length direction so as to allow one spacer or stacked spacers to be disposed therebetween. The grooves 60f, 60g are provided to hold a spacer comprising overlapped wedge-shaped members as disclosed in Patent Document 1.

The spacer holder 60 is provided at the lower portion of the front surface 60a with a plurality of protrusions 60p that are equally spaced at a pitch p1 in the circumferential direction. Each protrusion 60p has one surface (left surface) formed as a vertical surface 60r orthogonal to the front surface 60a and another surface (right surface) inclined to form an inclined surface 60q. As shown in FIGS. 9b and 9c, the spacer holder 60 is also provided at the rear surface 60b at the same locations as the front surface 60b with the protrusions 60p each having the vertical surface 60r and the inclined surface 60q. The distances between the inner wall surface 60m on the left side of the spacer holder 60 and the inclination end point of one of the inclined surfaces 60q are different by Δw, as will be described later. It is premised that the width W of the spacer 50 used is equal to the distance between the inclination end point of one of the inclined surfaces 60q and the inner wall surface 60m.

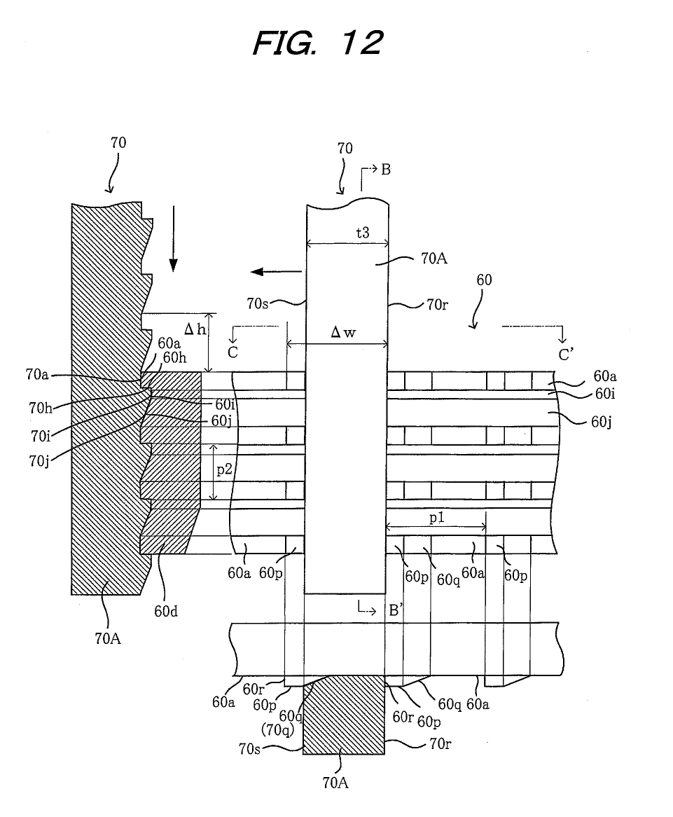

The protrusions 60p each having the vertical surface 60r and the inclined surface 60q extend horizontally and provide a protrusion arrangement. A plurality of protrusion arrangements (four in the present embodiment) are vertically provided on the front surface 60a and the rear surface 60b at equal intervals at a pitch p2. As shown in FIGS. 9c and 12, each protrusion arrangement has one side recessed in the direction orthogonal to the front surface 60a and the rear surface 60b to form a horizontal surface 60h, followed by a vertical surface 60i parallel to the front surface 60a and the rear surface 60b, and the vertical surface 60i is inclined toward the front surface 60a or the rear surface 60b to form an inclined surface 60j.

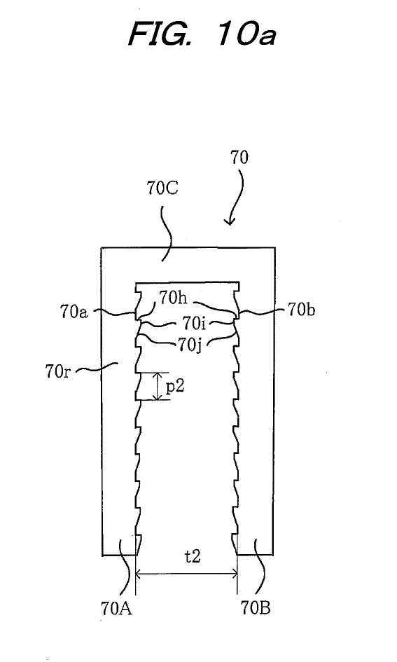

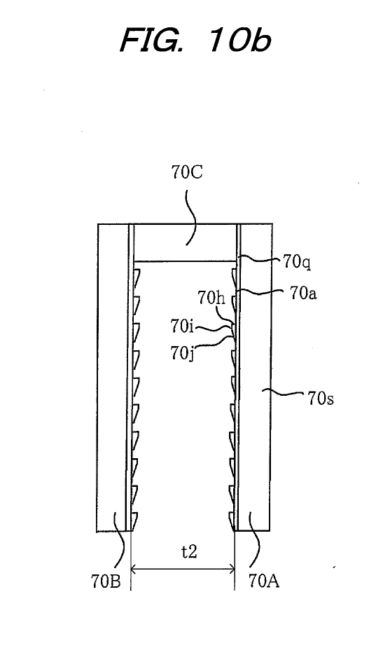

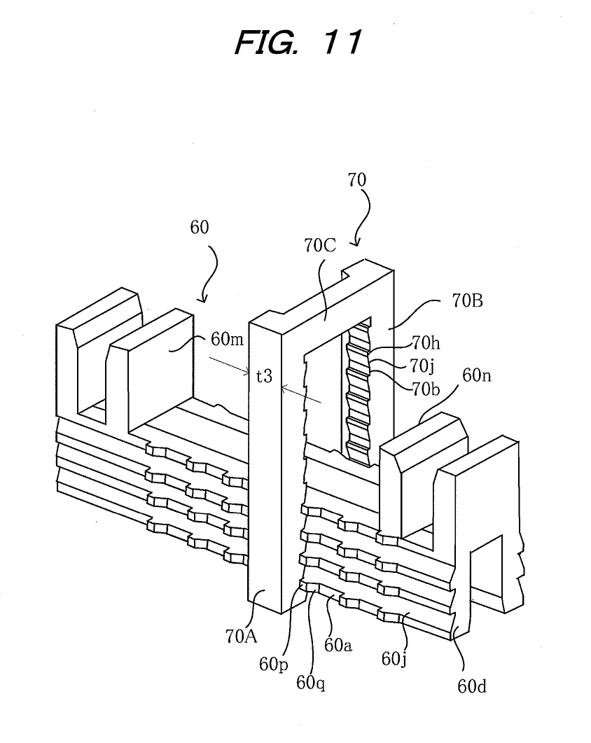

A movable member 70 as shown in FIGS. 10a, 10b and 11 is detachably attached to the spacer holder 60. The movable member 70 is made of elastic plastic, having two legs 70A and 70B that are integrally connected by a connector 70C. The movable member 70 is open on the side opposite the connector 70, and can be attached to or detached from the spacer holder 60 by expanding the open side thereof.

The legs 70A, 70B of the movable member 70 have inner side surfaces 70a, 70b, which are provided inside thereof at a pitch p2 with a plurality of horizontal surfaces 70h, vertical surfaces 70i and inclined surfaces 70j each corresponding in size to the horizontal surface 60h, the vertical surface 60i and the inclined surface 60j of the spacer holder 60, respectively. As shown in FIGS. 10a and 10b, the movable member 70 is flat at one side 70r (right side) and also flat at the other side 7s (left side). However, the surface toward the horizontal surface 70h, vertical surface 70i and the inclined surface 70j from the left side 70s is inclined to form an inclined surface 70q. As shown in the lower portion in FIG. 12, the inclined surface 70q aligns with the inclined surface 60q of the spacer holder 60 when the movable member 70 is attached thereto.

The distance between the inner side surfaces 70a, 70b of the legs 70A, 70B is equal to the distance t2 (FIG. 9c) between the front surface 60a and the rear surface 60b of the spacer holder 60. The circumferential width t3 of the movable member 70 (FIGS. 11 and 12) is the same as the distance between the vertical surface 60r of the spacer holder 60 and the inclination end point of the inclined surface 60q that faces the vertical surface 60r thereof.

In such a configuration, the spacer holder 60 is, as shown in FIG. 11, inserted between the legs 70A, 70B of the movable member 70 for attachment of the movable member 70 thereto. FIG. 12 shows a state in which the vertical surfaces and the horizontal surfaces of the spacer holder 60 engage with those of the movable member 70. The left cross-section in FIG. 12 is along B-B′ line and the lower cross-section is along C-C′ line.

The movable member 70 is attached to the spacer holder 60, for example, at a position as shown in FIG. 12. In this position, the horizontal surface 60h, the vertical surface 60i and the inclined surface 60j of the spacer holder 60 comes into contact with the horizontal surface 70h, the vertical surface 70i and the inclined surface 70j of the movable member 70, as shown on the left side in FIG. 12. On the other hand, the vertical surface 60r and the inclined surface 60q of the spacer holder 60 comes into contact with the right side surface 70r and the inclined surface 70q of the movable member 70, and the spacer holder 60 locks the movable member 70 in this position.

In this lock position, the right side surface 70r of the movable member 70 contacts the vertical surface 60r of the spacer holder 60, so that the movable member 70 cannot move to the right in FIG. 12. When, however, a force is applied to the left, as shown by the arrow, the movable member 70 slides on the inclined surface 60q of the spacer holder 60 over the protrusion 60p thereof, and is locked at the next lock positon.

On the other hand, the horizontal surface 70h of the movable member 70 contacts the horizontal surface 60h of the spacer holder 60, so that the movable member 70 cannot move upward in FIG. 12. When, however, a force is applied downward, as shown by the arrow, the movable member 70 slides on the inclined surface 60j of the spacer holder 60 over the vertical surface 60i thereof, and is locked at the next lock positon.

Thus, the movable member 70 can move to the left stepwise in increments of distance Δw between the vertical surfaces 60r and downward stepwise in increments of distance Δh between the inclination begin points of the inclined surface 70j. This allows the movable member 70 to be positioned in the circumferential and vertical directions depending upon the width of the spacer 50 and the number of spacer stacked.

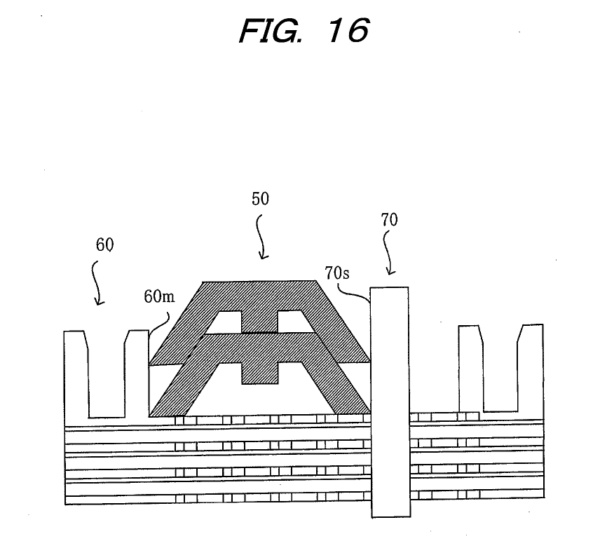

FIG. 16 shows a state in which two spacers 50 are stacked and held by spacer holder 60. The width W of the spacer 50 is set so as to be the same as the distance between the inner wall surface 60m and the inclination end point of one of the inclined surfaces 60q of the spacer holder 60. The spacers 50 are disposed between the inner wall surfaces 60m, 60n with their one ends (left ends) brought into contact with the inner wall surface 60m. The movable member 70 is then shifted to the left in increments of Δw until the distance between the left side surface 70s of the movable member 70 and the inner wall surface 60m reaches the width W of the spacer 50. In this position, the right side surface 70r of the movable member 70 comes into contact with the vertical surface 60r of the spacer holder 60, so that the movable member 70 can neither move to the right, nor to the left because the left side surface 70s thereof comes into contact with the right ends of the spacers 50, thus allowing the movable member 70 to be locked in this position. In this locking position of the movable member 70, the spacers 50 hit at their left ends the inner wall surface 60m and also at their right ends the left side surface 70s of the movable member 70, and is thus held between the inner wall surface 60m and the left side surface 70s of the movable member 70. Next, the movable member 70 is moved downward in increments of Δh to hold the spacers 50 between the inner wall surface 60m and the left side surface 70s of the movable member 70.

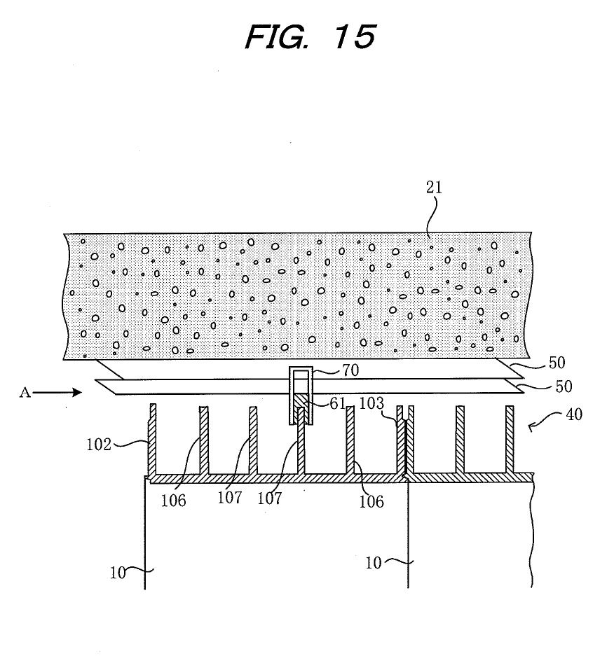

The spacer 50 is thus held by the spacer holder 60, which is then attached, for example, to the inner plate 107 of the segment 1, as shown in FIG. 14. The pipe unit with the spacers 50 attached to the segment thereof is, as shown in FIG. 15, inserted between the rehabilitation pipe 40 and the existing pipe 21. This allows the position of the rehabilitation pipe 40 to be adjusted relative to the existing pipe 21. Such a positional adjustment is performed every time the rehabilitation pipe is assembled a predetermined length (about one meter, for example).

As shown in FIG. 13, the spacer holder 60 together with the movable member 70 may first be attached to the segment, and then the spacer 50 may be held by the spacer holder 60. The step of attaching the spacer 50 to the segment using the spacer holder 60 may be performed before or after the pipe unit is assembled.

Once all the pipe units are linked in the pipe-length direction and the rehabilitation pipe 40 is installed so long as desired inside the existing pipe 21, the injection hole 41a is, as shown in FIG. 7, drilled in the segment 1, and the injection hose 41 is used to inject the filler 30 through the injection hole 41a into the space between the rehabilitation pipe 40 and the existing pipe 21. In cases where one spacer is used, or three or more spacers are stacked, the movable member 70 is shifted in the vertical direction depending thereon to hold the spacers.

### KEY TO THE SYMBOLS

1 segment
10 pipe unit
21 existing pipe
30 filler
40 rehabilitation pipe
50 spacer
60 spacer holder
70 movable member

What is claimed is:

1. A pipe rehabilitation method in which segments are linked in the circumferential direction and in the pipe-length direction to assemble a rehabilitation pipe inside an existing pipe and rehabilitate the existing pipe, comprising:
linking the segments in the circumferential direction to assemble a pipe unit;
attaching to the segment using a spacer holder a stackable elongated spacer that is inserted between the existing pipe and the rehabilitation pipe to adjust the position of the rehabilitation pipe inside the existing pipe;
linking the pipe units in the pipe-length direction while adjusting the position of the rehabilitation pipe relative to the existing pipe using the spacer; and
injecting a filler between the rehabilitation pipe and the existing pipe after installing the rehabilitation pipe inside the existing pipe,
wherein the spacer holder is provided with a movable member that is movable in the circumferential direction and in the vertical direction between the surfaces of inner walls that are formed on both circumferential ends thereof, and
wherein the movable member is positioned in the circumferential and vertical directions depending upon the circumferential width of the spacer and the number of spacers stacked, the spacer being held between the positioned movable member and the inner wall surface of the spacer holder.

2. A pipe rehabilitation method according to claim 1, wherein the movable member is detachably attached to the spacer holder.

3. A pipe rehabilitation method according to claim 1, wherein the movable member is movable stepwise in only one direction in the circumferential direction and in the vertical direction.

4. A pipe rehabilitation method according to claim 1, wherein the spacer holder is provided with a plurality of protrusion arrangements in which protrusions each having a vertical surface at one surface and an inclined surface at the other surface are arranged in the circumferential direction at equal intervals, and the movable member is brought into contact with the vertical surface thereof for lock to limit the circumferential movement of the movable member.

5. A pipe rehabilitation method according to claim 4, wherein a horizontal surface is formed between the protrusion arrangement and the protrusion arrangement adjacent thereto in the vertical direction, and the movable member is provided at its attachment surface with a horizontal surface that comes into contact with the horizontal surface of the protrusion arrangement, both the horizontal surfaces being brought into contact with each other to limit the vertical movement of the movable member.

6. A pipe rehabilitation method according to claim 1, wherein the spacer holder is first attached to the segment, and the spacer is then held by the spacer holder.

7. A pipe rehabilitation method according to claim 1, wherein the spacer is first held by the spacer holder, and the spacer holder that holds the spacer is attached to the segment.
